(19) United States
(12) Patent Application Publication
(10) Pub. No.: US 2019/0163311 A1
(43) Pub. Date: May 30, 2019

(54) FOAM TAPE FOR FORCE-SENSITIVE TOUCH SENSOR

(71) Applicant: 3M INNOVATIVE PROPERTIES COMPANY, St. Paul, MN (US)

(72) Inventor: Jiwoong Kong, Hwaseong-si (KR)

(21) Appl. No.: 16/191,775

(22) Filed: Nov. 15, 2018

(30) Foreign Application Priority Data
Nov. 29, 2017 (KR) 10-2017-0161684

(51) Int. Cl. G06F 3/041

(52) U.S. Cl. CPC G06F 3/0414; G06F 3/0416

(57) ABSTRACT

A foam tape for a force-sensitive touch sensor includes a first adhesion layer, a support layer arranged on the first adhesion layer, a foam layer arranged on the support layer and including closed cell bubbles, and a second adhesion layer arranged on the foam layer. At least a portion of some of the closed cell bubbles protrudes from a surface of the foam layer.

### BACKGROUND

### Technical Field

The present disclosure relates to a foam tape for a force-sensitive touch sensor, and more particularly, to a foam tape which is used in a touch sensor for detecting an intensity of a pressing force and an operation position.

### Background Art

In recent years, touch input technology of selecting or inputting a function desired by a user by contacting with an input device, such as a finger, a stylus, or etc., is applied to various electronic products such as a mobile phone, a laptop, a personal digital assistant (PAD), or the like.

An electronic product employing the related-art touch input technology may include a plurality of sensing electrodes to detect x-axis and y-axis detection signals, and may detect only a position contacted by an input device. That is, the related-art touch input technology has a limit of sensing and detecting only contact position information.

Therefore, since the related-art touch input technology cannot sense information regarding an intensity of a pressing force, there is a problem that a user cannot perform a feedback function according to a change in the pressing force. For example, a feedback function customized to a variety of input information, such as a change in the width of a pen or concentration, or a change in zoom-in and zoom-out according to an intensity of a pressing force cannot be provided.

To solve this problem, there has been a need for development of a device which can obtain not only a position of an input device, but also information regarding a position and an intensity of a pressing force, and various force-sensitive touch sensors for sensing a pressing force have been developed.

Such a force-sensitive touch sensor normally has an upper base material and a lower base material arranged to have an air gap therebetween. An intensity of a pressing force may be detected based on a difference in the distance between the upper base material and the lower base material, which changes by a pressing force, that is, a difference in the height of the air gap.

However, a rigid support member such as a cover, etc. for supporting the upper base material and the lower base material is required to maintain the air gap, and a volume may increase due to the presence of such a support member, and also, there is a problem that it is difficult to apply the force-sensitive touch sensor to a flexible device, etc.

In addition, the support member, etc. may be damaged by an external shock, etc. as it is used, and it is difficult to constantly maintain the air gap and to guarantee durability. There is also a disadvantage that sensing performance is degraded in detecting a position and an intensity of a pressing force.

### SUMMARY

### Technical Problem

An object of the present disclosure is to provide a foam tape for a force-sensitive touch sensor, which does not require a support member for maintaining an air gap between an upper base material and a lower base material, and is disposed between an upper base material and a lower base material in replacement of an air gap, and is usable in a flexible device, etc.

In addition, another object of the present disclosure is to provide a foam tape for a force-sensitive touch sensor, which can reduce a volume of an electronic device applying touch input technology, by omitting a support member for maintaining an air gap.

Furthermore, still another object of the present disclosure is to provide a foam tape for a force-sensitive touch sensor, which provides a force-sensitive touch sensor having high durability and enhanced sensing performance.

### Technical Solution

To solve the above-described technical problems of the related-art technology, a foam tape for a force-sensitive touch sensor of the present disclosure comprises: a first adhesion layer; a support layer arranged on the first adhesion layer; a foam layer arranged on the support layer, and comprising closed cell bubbles; and a second adhesion layer arranged on the foam layer, wherein at least a portion of some of the closed cell bubbles protrudes from a surface of the foam layer.

The foam layer may be a silicone layer.

The second adhesion layer may be a silicone-based adhesion layer.

The closed cell bubble may have a diameter ranging from 20 μm to 100 μm.

The foam layer may include opened cell bubbles and closed cell bubbles.

A ratio of the opened cell bubbles to the closed cell bubbles may be 1:9 or higher with reference to a number of cell bubbles.

The support layer may be a polymer film.

The support layer may include one or more of a PET film, a PI film, and a PEN film.

The foam tape for the force-sensitive touch sensor may further include a ground layer, and the ground layer may be arranged on an upper portion of the second adhesion layer or a lower portion of the first adhesion layer.

### Advantageous Effects

A support member for maintaining an air gap between an upper base material and a lower base material may not be required by using the foam tape for the force-sensitive touch sensor according to the present disclosure. That is, the foam tape is arranged between the upper base material and the lower base material in replacement of the air gap, such that volumes of a touch module and an electronic device can be reduced, and touch performance can be maintained and enhanced.

Furthermore, the foam tape for the force-sensitive touch sensor described above has high durability, and is applicable to a flexible touch module and an electronic device.

In addition, the foam tape for the force-sensitive touch sensor according to the present disclosure has high durability, and a force-sensitive touch sensor having enhanced sensing performance can be provided.

### BRIEF DESCRIPTION OF THE DRAWINGS

FIG. 1 is a view illustrating a touch module including a related-art force-sensitive touch sensor;

FIG. 2 is a view illustrating a touch module including a foam tape for a force-sensitive touch sensor of the present disclosure;

FIG. 3 is a view illustrating a foam tape for a force-sensitive touch sensor according to an embodiment of the present disclosure;

FIG. 4 is a view illustrating a foam tape for a force-sensitive touch sensor according to another embodiment of the present disclosure;

FIG. 5 is a view illustrating a foam tape for a force-sensitive touch sensor according to still another embodiment of the present disclosure;

FIGS. 6A to 6C are views illustrating a difference in displacement according to a load; and

FIGS. 7A to 7D are views illustrating a difference in displacement according to a material of a foam layer.

### DETAILED DESCRIPTION

In the detailed descriptions for embodying the present disclosure as presented below, some specific embodiments forming a portion of the present specification refer to the accompanying drawings by way of an example. However, it should be understood that other embodiments are considered without departing from the scope or idea of the present disclosure. Accordingly, the detailed descriptions for embodying the present disclosure as presented below should not be considered as limiting.

All of the scientific and technical terms used in the present specification have meanings generally used in the related art unless they are defined otherwise. The definition provided in the present specification is for easy understanding of a term frequently used in the present specification, and does not limit the scope of the present disclosure.

Shapes, sizes, ratios, angles, numbers, etc. disclosed in the drawings to explain embodiments of the present disclosure are exemplary, and thus the present disclosure is not limited to the matters illustrated in the drawings. The same reference numerals indicate the same elements throughout the specification. Further, in explaining the present disclosure, detailed descriptions of well-known relevant technology will be omitted since they would unnecessarily obscure the subject matters of the present disclosure.

It should be understood that all numerical values representing sizes, quantities, and physical properties of characteristic portions used in the detailed descriptions and the claims are modified by the term “about” in all cases unless otherwise specified. Therefore, unless otherwise indicated, numerical value parameters described in the detailed descriptions and the appended claims are approximate values which may be changed according to a desired characteristic that those skilled in the art wish to obtain using the features disclosed in the present specification.

As used in the detailed descriptions and the appended claims, the singular forms (“a”, “an”, and “the”) are intended to include the plural forms as well, unless the context clearly indicates otherwise. As used in the detailed descriptions and the appended claims, the term “or” is intended to include the meaning of “and/or” in addition to its meaning unless the context clearly indicates otherwise.

As used in the present specification, the terms related to spaces, including, but not limited to, “lower portion,” “upper portion”, “under”, “below”, “above”, and “on an upper portion,” are used to describe a spatial relationship of an element(s) with another element for convenience of explanation.

Such terms related to spaces include different orientations of a device which is in use or is operating, in addition to a specific orientation illustrated in the drawings and described in the detailed descriptions. For example, when an object illustrated in the drawings is reversed or turned over, a portion previously described as being below or under another element may be above another element.

When a position relationship is explained in the present disclosure, for example, a position relationship between two portions, such as “˜on,” “˜on an upper portion,” “˜on a lower portion,”, “˜beside,” etc., is explained, there may be one or more other portions between the two portions unless the expression “directly” is used.

In the present disclosure, when the terms “have,” “include,” “is provided with,” or the like are used, they are used as their open meanings, and indicate addition of other elements in addition to elements described unless the expression “only” is used.

Hereinafter, embodiments of the present disclosure will be described in detail with reference to the accompanying drawings. Respective features of embodiments of the present disclosure may be coupled to or combined with one another in part or entirely, and technically various interlocking and driving are possible.

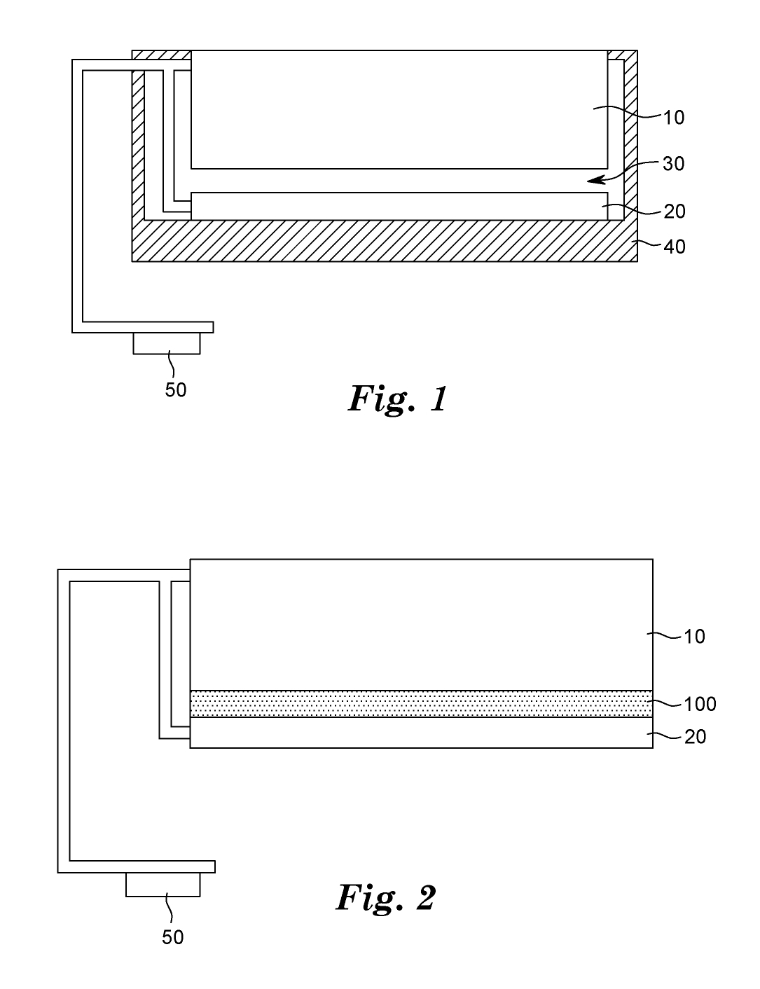

FIG. 1 is a view illustrating a related-art touch module, and FIG. 2 is a view illustrating a touch module including a foam tape for a force-sensitive touch sensor of the present disclosure.

Referring to FIG. 1, the touch module including the related-art force-sensitive touch sensor has an upper base material 10 and a lower base material 20 arranged to have an air gap 30 therebetween, and includes a rigid support member 40 to constantly maintain the air gap 30. The upper base material 10 and the lower base material 20 are connected with a touch integrated circuit (IC) 50.

The upper base material 10 or the lower base material 20 may include a display module such as a liquid crystal display (LCD) module or an organic light emitting diode (OLED) module, and the display module may further include a touch sensor to sense and detect contact position information of a touch input device. However, a position and an intensity of a pressing force may be detected by sensing a difference in the height of the air gap 30 caused by the pressing force, that is, a displacement, and by converting the displacement into an electric signal.

To constantly maintain the air gap 30, the support member 40 is required. Since the support member 40 is formed of a rigid material, it is difficult to apply the touch module to a flexible device which is foldable or bendable. In addition, a volume of a device including the support member 40 may increase due to a space where the support member 40 is installed, and there is a disadvantage that it is difficult to apply the support member 40 to a large area.

Furthermore, when the support member 40, etc. is damaged by an external shock, etc., it is difficult to constantly maintain the air gap and there is a problem in guaranteeing durability.

Referring to FIG. 2, a touch module including a foam tape for a force-sensitive touch sensor of the present disclosure has a foam tape 100 for a force-sensitive touch sensor disposed between an upper base material 10 and a lower base material 20, in replacement of an air gap. The upper base material 10 and the lower base material 20 are connected with a touch IC 50.

The upper base material 10 or the lower base material 20 may include a display module such as an LCD module or an OLED module, and the display module may further include a touch sensor to sense and detect contact position information of a touch input device. In this case, a position and an intensity of a pressing force may be detected by sensing a change in the thickness of the foam tape 100 for the force-sensitive touch sensor, caused by the pressing force, that is, a displacement, and by converting the displacement into an electric signal.

Compared with the related-art touch module, the touch module using the foam tape 100 for the force-sensitive touch sensor of the present disclosure may omit an empty space between the upper base material 10 and the lower base material 20, that is, an air gap, and may omit a support member for maintaining the air gap.

Accordingly, volumes of the touch module and an electronic device including the same can be reduced. In addition, the foam tape 100 for the force-sensitive touch sensor is applicable to a flexible device.

Furthermore, the foam tape 100 for the force-sensitive touch sensor has a uniform thickness, is flexible, and has good elasticity and restoring force. Accordingly, when the foam tape 100 for the force-sensitive touch sensor is used, a damage to a support member caused by an external shock can be avoided, and the touch module and the electronic device having high durability can be provided.

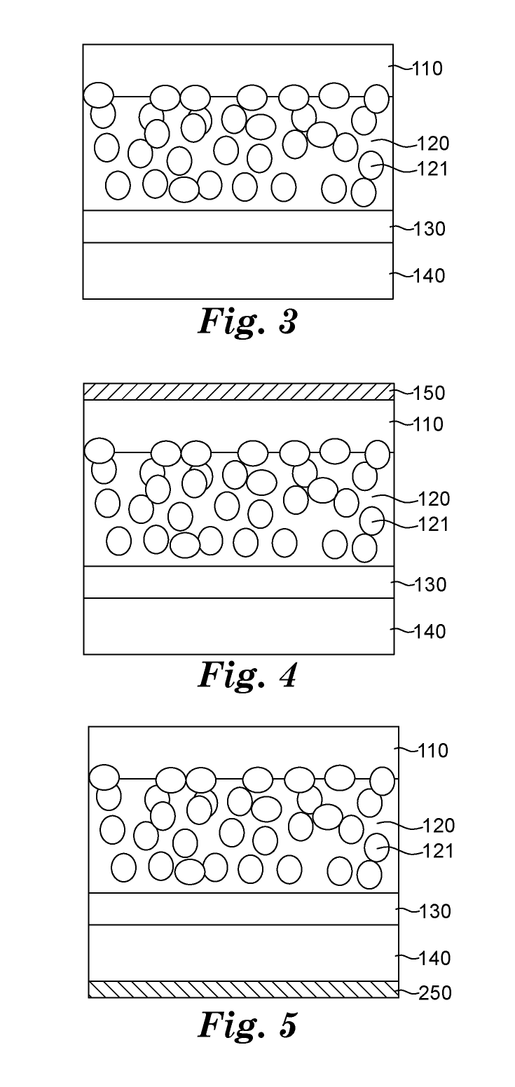

The foam tape 100 for the force-sensitive touch sensor of the present disclosure will be described in detail with reference to FIG. 3. FIG. 3 is a view illustrating a foam tape for a force-sensitive touch sensor according to an embodiment of the present disclosure.

Referring to FIG. 3, the foam tape for the force-sensitive touch sensor of the present disclosure comprises a first adhesion layer 140, a support layer 130 arranged on the first adhesion layer 140, a foam layer 120 arranged on the support layer 130 and including a plurality of cell bubbles 121 including a cell bubble, and a second adhesion layer 110 arranged on the foam layer 120.

The foam layer 120 may be flexible and may have elasticity and a restoring force, and may maintain a constant displacement when being pressed. The foam layer 120 may include silicone. That is, the foam layer 120 may be a silicone layer.

When the foam layer 120 is formed by a silicone layer, the elastic property to temperature is less changed, and reliability at high temperature and low temperature is excellent. In addition, the foam layer 120 is advantageous to maintaining a constant displacement when a constant pressing force is applied, and is rapidly restored when the pressing force is removed.

In addition, the foam layer 120 includes the plurality of cell bubbles 121, and some of the plurality of cell bubbles 121 are arranged to protrude toward the second adhesion layer 110.

The foam layer includes closed cell bubbles. The foam layer 120 may include opened cell bubbles and closed cell bubbles. Some of the closed cell bubbles are arranged to have at least a portion thereof protrude from a surface of the foam layer 120.

When the surface of the foam layer 120 is flat, and a pressing force is applied from the direction of the second adhesion layer 110, a peripheral region of a position to which the pressing force is applied is influenced by the pressing force, thereby causing a difference in displacement. Therefore, it may be difficult to exactly sense a position and an intensity of the pressing force. However, in the foam tape for the force-sensitive touch sensor of the present disclosure, some of the plurality of cell bubbles 121 are arranged to protrude toward the second adhesion layer 110, such that, when a pressing force is applied, an influence on peripheral portions can be reduced due to the protrusions, and a touch can be exactly recognized.

In this case, the plurality of cell bubbles 121 may have diameters ranging from 20 μm to 100 μm, respectively, to have appropriate elasticity and restoring force. Preferably, the closed cell bubble has a diameter ranging from 20 μm to 100 μm.

In addition, 90% or more of the cell bubbles 121 may be closed cell bubbles with reference to the total number of cell bubbles 121 included in the foam layer 120. That is, a ratio of the opened cell bubbles to the closed cell bubbles is 1:9 or higher with reference to the number of cell bubbles. Preferably, 95% or more of the cell bubbles 121 are closed cell bubbles, and more preferably, all of the cell bubbles 121 (100%) are closed cell bubbles. When the opened cell bubbles are 10% or more, it may be difficult to guarantee elasticity and restoring force of the foam layer 120, and the foam layer 120 may be destroyed.

The first adhesion layer 140 may adhere to a lower base material, and the second adhesion layer 110 may adhere to an upper base material. In this case, the pressing force may be applied onto the second adhesion layer 110.

Although not shown, a liner may further be arranged on a lower portion of the first adhesion layer 140 and an upper portion of the second adhesion layer 110 before the foam tape for the force-sensitive touch sensor is attached to the upper base material or the lower base material.

The first adhesion layer 140 and the second adhesion layer 110 may be formed by the same material or different materials. When the foam layer 120 is a silicone layer, the second adhesion layer 110 may be a silicone-based adhesion layer to guarantee adhesion.

For example, the first adhesion layer 140 may be an acrylic adhesion layer, and the second adhesion layer 110 may be a silicone-based adhesion layer. However, this should not be considered as limiting, and the first adhesion layer 140 and the second adhesion layer 110 may be formed by a material that can attach the foam tape for the force-sensitive touch sensor to the upper base material or the lower base material.

The support layer 130 may be formed by a material that can perform the role of supporting the plurality of layers of the foam tape for the force-sensitive touch sensor. Preferably, the support layer 130 may be a flexible film. For example, the support layer 130 may be a polymer film, and preferably, may include one or more of a PET film, a PI film, and a PEN film. When a flexible film is used as the support layer 130, the foam tape can be applied to a flexible device, etc.

Next, a foam tape for a force-sensitive touch sensor according to another embodiment of the present disclosure will be described with reference to FIG. 4. Portions overlapping with those of the above-described embodiment will not be described, and the same reference numerals indicate the same elements. FIG. 4 is a view illustrating a foam tape for a force-sensitive touch sensor according to another embodiment of the present disclosure.

Referring to FIG. 4, the foam tape for the force-sensitive touch sensor of the present disclosure comprises a first adhesion layer 140, a support layer 130 arranged on the first adhesion layer 140, a foam layer 120 arranged on the support layer 130 and including a plurality of cell bubbles 121 including a cell bubble, a second adhesion layer 110 arranged on the foam layer 120, and a ground layer 150 arranged on the second adhesion layer 110. The ground layer 150 may be arranged on an upper portion of the second adhesion layer 110, and may induce electrical grounding of the foam tape for the force-sensitive touch sensor. The ground layer 150 may include copper, but is not limited thereto, and may be formed by any material that can induce electrical grounding.

Next, a foam tape for a force-sensitive touch sensor according to still another embodiment of the present disclosure will be described with reference to FIG. 5. Portions overlapping with those of the above-described embodiments will not be described, and the same reference numerals indicate the same elements. FIG. 5 is a view illustrating a foam tape for a force-sensitive touch sensor according to still another embodiment of the present disclosure.

Referring to FIG. 5, the foam tape for the force-sensitive touch sensor of the present disclosure comprises a ground layer 250, a first adhesion layer 140 arranged on the ground layer 250, a support layer 130 arranged on the first adhesion layer 140, a foam layer 120 arranged on the support layer 130 and including a plurality of cell bubbles 121 including a cell bubble, and a second adhesion layer 110 arranged on the foam layer 120.

The ground layer 250 may be arranged on a lower portion of the first adhesion layer 140, and may induce electrical grounding of the foam tape for the force-sensitive touch sensor. The ground layer 250 may include copper, but is not limited thereto, and may be formed by any material that can induce electrical grounding.

In addition, although not shown, a third adhesion layer may further be arranged on a lower portion of the ground layer 250. The third adhesion layer may be formed by the same or different material as or from that of the first adhesion layer 140.

Hereinafter, the foam tape for the force-sensitive touch sensor according to the present disclosure will be described in detail through experiment examples as presented below. The examples presented below are just for illustratively explaining the present disclosure, and the scope of the present disclosure is not limited by the following examples.

### Experiment Example 1—Restoring Speed

A restoring speed was measured in response to one pressure input in example 1 and comparison examples 1 to 3 prepared as shown in table 1 presented below:

TABLE 1

| | | | | Comparison | Comparison | Comparison |
|---|---|---|---|---|---|---|
| | | | | Example 1 | Example 2 | Example 3 |
| Specification | | Unit | Example 1 | (PU foam A) | (PU foam B) | (PU foam C) |
| Base resin | | | Si | PU | PU | PU |
| Manufacturer | | | | Dooroo celltech | Dooroo celltech | GM Innotech |
| Foam density | | g/cm2 | 0.34 | 0.2 | 0.25 | 0.27 |
| Thickness of a foam layer | | μm | 80 | 75 | 75 | 100 |
| Thickness of a support | | μm | 5 | 25 | 25 | 0 |
| layer | | | | | | |
| Thickness of a lower liner | | μm | 75 | 50 | 50 | 50 |
| Thickness of an upper | | μm | 25 | 12 | 12 | 12 |
| adhesion layer | | | | | | |
| Total thickness | | μm | 110 | 112 | 112 | 112 |
| Thickness of a ground | | μm | 18 | 18 | 18 | 18 |
| layer | | | | | | |
| Thickness of a sample | | μm | 128 | 130 | 130 | 130 |
| 95% restored | 0.5 kg | sec | <0.5 | ~1.2 | >1.5 | ~1.2 |
| | 1.0 kg | | <0.5 | ~1.0 | >1.5 | ~1.0 |
| | 2.0 kg | | <0.5 | <0.5 | >1.5 | <0.5 |
| | 3.0 kg | | ~0.8 | <0.5 | >1.5 | <0.5 |
| 100% restored | 0.5 kg | | <0.5 | ~2.0 | >1.5 | ~2.0 |
| | 1.0 kg | | <0.5 | ~2.0 | >1.5 | ~2.0 |
| | 2.0 kg | | <0.5 | ~1.5 | >1.5 | ~1.5 |
| | 3.0 kg | | ~0.8 | ~1.5 | >1.5 | ~1.5 |

Comparing example 1 and comparison examples 1 to 3, it can be seen from table 1 that there was no big difference in the restoring speed when high pressure of 3 kg is inputted, but the restoring speed of example 1 including silicone was noticeably higher than the restoring speeds of the comparison examples including PU in a low pressure section of 0.5 kg or 1 kg.

In particular, it can be seen that, in comparison examples 1 to 3 including PU foam, there was time delay between the time that 95% was restored and the time that 100% was restored, and longer time than in example 1 was required. Accordingly, the present disclosure including silicone foam has better restoring performance than the case including PU foam.

### Experiment Example 2—Displacement

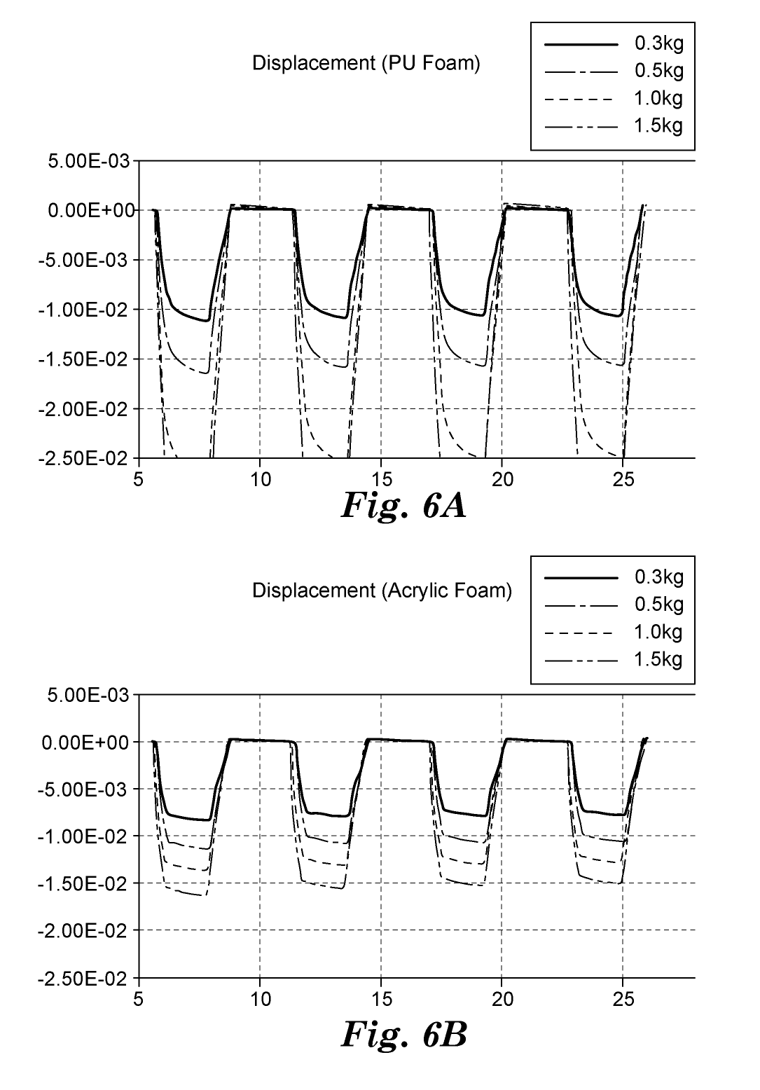

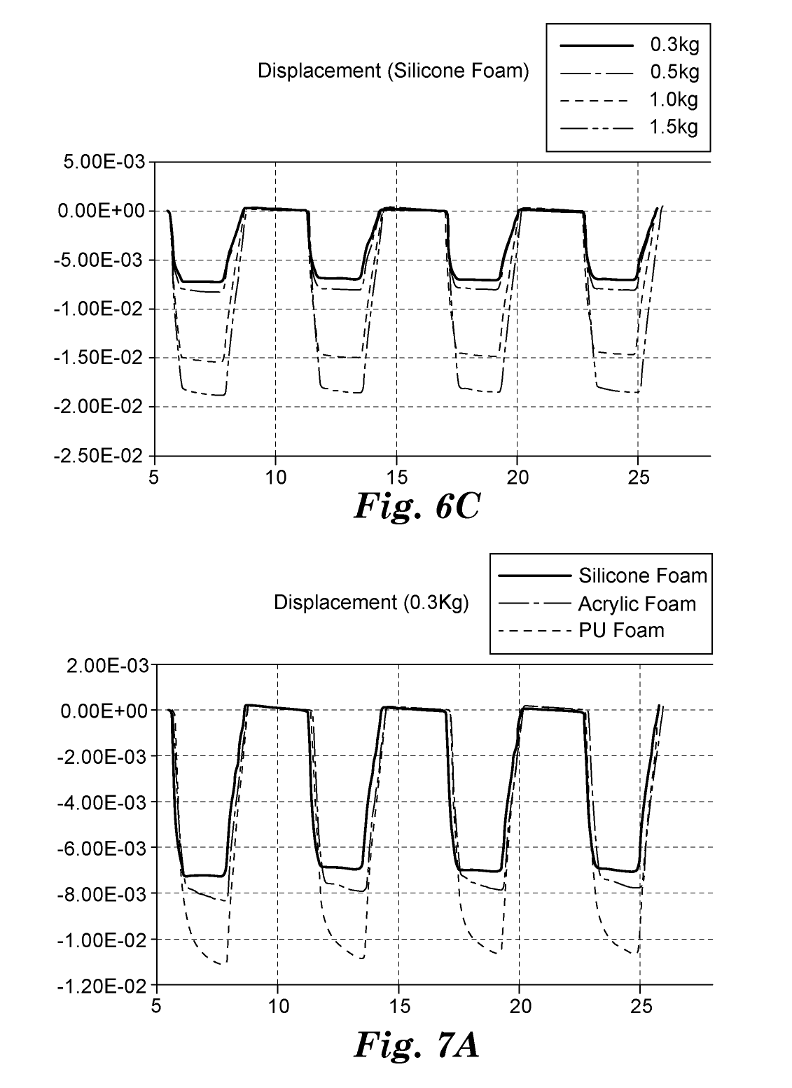

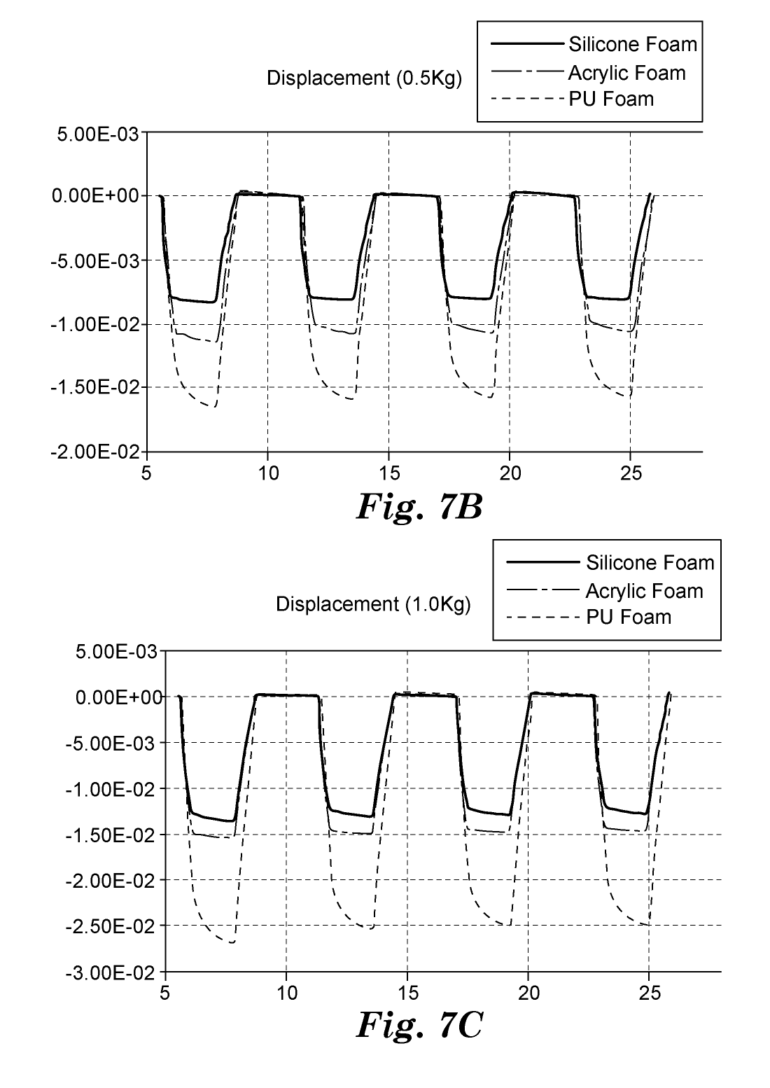

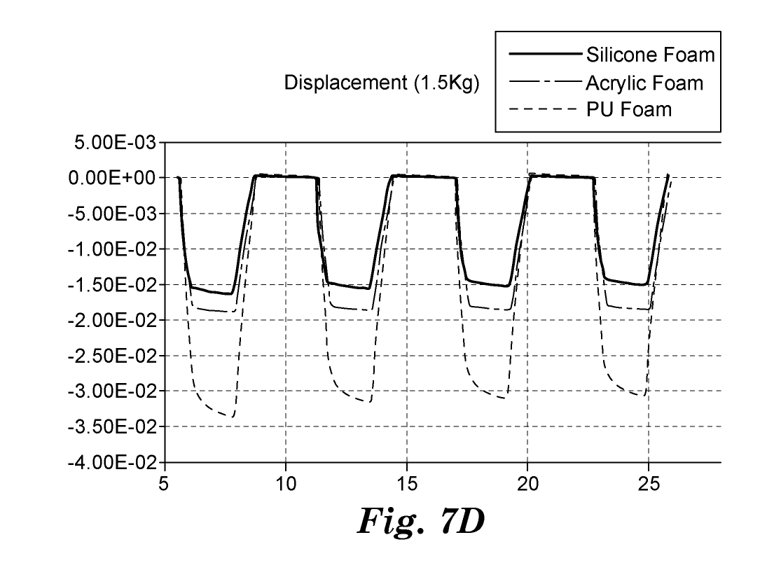

FIGS. 6A to 6C are views illustrating a difference in displacement according to loads of foam tapes including PU foam, acrylic foam, and silicone foam, respectively, and FIGS. 7A to 7D are views illustrating a difference in displacement according to each load of the foam tapes including PU foam, acrylic foam, and silicone foam.

As explained below, comparison example 4, comparison example 5, and example 2 were prepared to have similar total thickness, and loads of 0.3 kg, 0.5 kg, 0.1 kg, and 1.5 kg were applied in comparison example 4, comparison example 5, and example 2, and the results therefrom are illustrated in FIGS. 6A to 6C, and FIGS. 7A to 7D.

### Comparison Example 4

A foam tape having total thickness of 155 μm, including thickness of 130 μm, which is the sum of PU foam and a copper layer (ground layer), and thickness of 25 μm of a PET film (support layer), was manufactured.

Referring to FIG. 6A, it can be seen that, in the case of PU foam, displacement was not constant and was greatly changed even while a constant load was held after being applied, and long time was required to restore when the load was removed. In particular, it can be seen that, as a heavy load was applied, a change in displacement was very big, and in particular, such a change was very big at the beginning time when the load was applied.

### Comparison Example 5

A foam tape having total thickness of 155 μm, including thickness of 130 μm, which is the sum of acrylic foam and a copper layer (ground layer), and thickness of 25 μm of a PET film (support layer), was manufactured.

Referring to FIG. 6B, it can be seen that, in the case of acrylic foam, displacement was constantly maintained in comparison to the case where PU foam was included, but displacement was changed when a constant load was applied. In addition, it can be seen that the corresponding acrylic foam had a relatively small difference in displacement according to each pressure, and thus it was difficult to distinguish the difference.

### Example 2

A foam tape having total thickness of 155 μm, including thickness of 150 μm, which is the sum of silicone foam and a copper layer (ground layer), and thickness of 5 μm of a PET film (support layer), was manufactured.

Referring to FIG. 6C, it can be seen that, in the case of silicone foam, displacement was almost constantly maintained while a constant load was applied.

Referring to FIGS. 7A to 7C, the difference between example 2 and comparison examples 4 and 5 can be more clearly identified. In particular, the difference between example 2 and comparison examples 4 and 5 is noticeable when lower pressure like 0.3 kg and 0.5 kg is applied.

Although embodiments according to the present disclosure have been described, it will be understood by an ordinary person skilled in the related art that various changes can be made therefrom and other equivalent embodiments are possible. Therefore, the scope of the present disclosure should be construed as including not only the claims presented below but also an equivalent scope thereto.

### DESCRIPTION OF REFERENCE NUMERALS

10: Upper base material, 20: Lower base material, 30: Air gap, 40: Support member, 50: Touch IC, 100: Foam tape for a force-sensitive touch sensor, 110: Second adhesion layer, 120: Foam layer, 121: Cell bubble, 130: Support layer, 140: First adhesion layer

What is claimed is:

1. A foam tape for a force-sensitive touch sensor, comprising:
a first adhesion layer;
a support layer arranged on the first adhesion layer;
a foam layer arranged on the support layer, and comprising closed cell bubbles; and
a second adhesion layer arranged on the foam layer,
wherein at least a portion of some of the closed cell bubbles protrudes from a surface of the foam layer.

2. The foam tape of claim 1, wherein the foam layer is a silicone layer.

3. The foam tape of claim 2, wherein the second adhesion layer is a silicone-based adhesion layer.

4. The foam tape of claim 1, wherein the closed cell bubble has a diameter ranging from 20 μm to 100 μm.

5. The foam tape of claim 1, wherein the foam layer comprises opened cell bubbles and closed cell bubbles.

6. The foam tape of claim 5, wherein a ratio of the opened cell bubbles to the closed cell bubbles is 1:9 or higher with reference to a number of cell bubbles.

7. The foam tape of claim 1, wherein the support layer is a polymer film.

8. The foam tape of claim 1, wherein the support layer comprises one or more of a PET film, a PI film, and a PEN film.

9. The foam tape of claim 1, further comprising:
a ground layer,
wherein the ground layer is arranged on an upper portion of the second adhesion layer or a lower portion of the first adhesion layer.
